(19) United States
(12) Patent Application Publication
(10) Pub. No.: US 2024/0401942 A1
(43) Pub. Date: Dec. 5, 2024

(54) MEASUREMENT STRUT

(71) Applicant: RENISHAW PLC, Wotton-under-Edge, Gloucestershire (GB)

(72) Inventors: Stephen Mark ANGOOD, Wotton-under-Edge (GB); David James FOOK, Wotton-under-Edge (GB)

(73) Assignee: RENISHAW PLC, Wotton-under-Edge, Gloucestershire (GB)

(21) Appl. No.: 18/690,648

(22) PCT Filed: Sep. 8, 2022
(86) PCT No.: PCT/GB2022/052281

§ 371 Date: Mar. 8, 2024

(30) Foreign Application Priority Data
Sep. 9, 2021 (GB) 2112834.3

(51) Int. Cl. G01B 21/04; B25J 9/16; G01B 21/16

(52) U.S. Cl. CPC G01B 21/04; B25J 9/1679; G01B 21/16

(57) ABSTRACT

A measurement strut for measuring a separation between two relatively moveable support members of a machine (for example, a robot arm). The strut is removably couplable between the two support members and is adapted to become at least partially decoupled from at least one of the support members when a compressive force developed in the strut by relative movement of the support members is greater than a predetermined threshold. By becoming at least partially decoupled from at least one of the support members, at least some of any excess relative movement of the support members towards each other can be absorbed, thereby helping to prevent damage being caused to the strut by attempting to compress the strut beyond its minimum range of travel.

The present invention relates to a measurement strut. Such a measurement strut or a plurality of such measurement struts can be used, for example, to calibrate a coordinate positioning machine, such as an articulated robot or a measurement arm.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

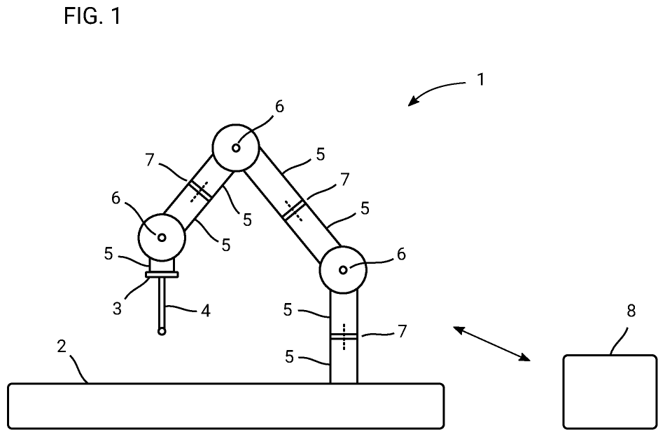

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools.

The arm 1 comprises a plurality of segments 5 connected by a mixture of transverse rotary joints 6 and inline rotary joints 7, forming a mechanical linkage from one end to the other. In the example illustrated in FIG. 1, there are three transverse rotary joints 6 and three inline rotary joints 7, making a total of six rotary joints, alternating between transverse rotary joints 6 and inline rotary joints 7. An additional inline rotary joint 7 could also be provided between the final transverse rotary joint 6 and the flange 3, to provide convenient rotation of the tool 4 around its longitudinal axis, making a total of seven rotary joints.

Calibration of any type of non-Cartesian machine is a significant challenge, and particularly so for an articulated arm such as that illustrated in FIG. 1 having a plurality of rotary joints that are not fixed relative to one another and that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a plurality of parameters is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined. The task of calibrating the machine then amounts to determining a set of values for the machine various parameters that minimises the errors, using known numerical optimisation or error minimisation techniques.

For a robot as illustrated in FIG. 1, these machine parameters might include various geometrical parameters such as the length of each of the segments 5 and the rotation angle offset of each of the rotational joints 6, 7 (with the angle from the encoder plus the calibrated offset giving the actual angle), as well as various mechanical parameters such as joint compliance and friction. When properly calibrated, with all of these machine parameters known, it is possible to predict with more certainty in what position the tool 4 will actually be when the various joints 6, 7 are commanded by a robot controller 8 to move to different respective positions. In other words, the machine parameters resulting from such a calibration provide a more accurate characterisation of the machine geometry.

These concepts, relating to calibration of coordinate positioning machines in general and robot arms in particular, are explored in greater detail in WO 2019/162697 A1 and WO 2021/116685 A1.

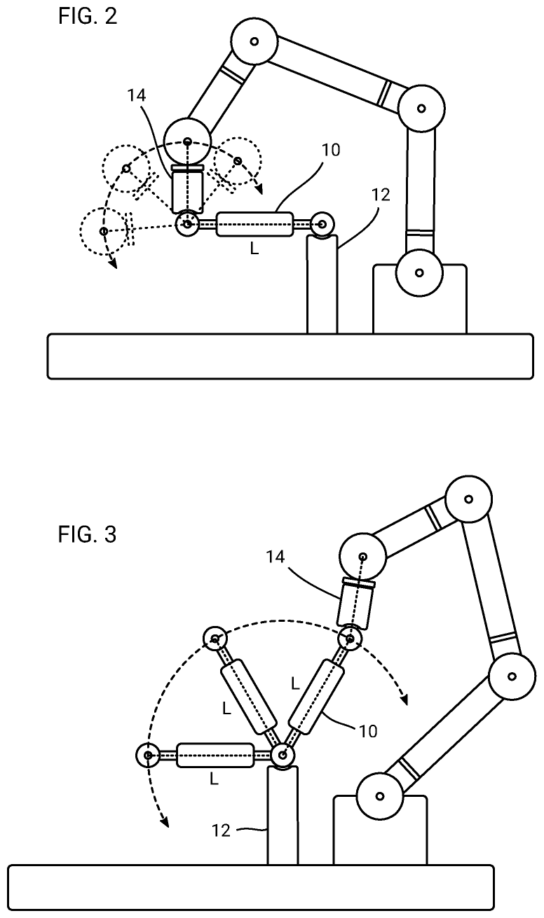

It has been previously considered to use a length-measuring bar, commonly referred to as a “ballbar”, to calibrate a robot arm. An example of such a ballbar is the QC20-W wireless ballbar made and sold by Renishaw plc. FIG. 2 illustrates the use of a ballbar 10 to calibrate the tool centre point (TCP) of a robot arm similar to that of FIG. 1. In this method, a ballbar 10 is attached between a first ballbar mount 12 fixed to the base of the machine and a second ballbar mount 14 attached to the robot arm itself. Therefore, in this example the tool 4 of FIG. 1 has been replaced by the ballbar mount 14, which has a magnetic cup into which the ball at one end of the ballbar 10 locates. When the robot arm is commanded to rotate around the TCP, the TCP remains almost fixed but moves slightly because of calibration errors. Length measurements L from the ballbar 10 can be used as calibration data to correct the TCP coordinates using an error minimisation technique as mentioned previously. This is described in more detail in WO 2019/162697 A1. FIG. 3 illustrates another type of calibration routine in which the robot arm is controlled to perform wider movements around the working volume, with the ballbar 10 still attached, nominally keeping the ballbar 10 at a constant length (based on the existing machine parameters). Again, length measurements L from the ballbar 10 can be used to update the machine parameters to improve the overall calibration of the robot.

The present applicant has appreciated that, when the robot arm is being controlled to perform movements like those shown in FIGS. 2 and 3 during a calibration routine, there is a risk that the ballbar 10 may inadvertently be driven beyond its normal range of travel, particularly for larger movements such as shown in FIG. 3. This may be due to errors in the current machine parameters (so that the end of the robot arm, and hence the moving end of the ballbar 10, is not where it is expected to be), or due to errors in programming the robot controller 8 for the calibration routine, or due to human error when manually controlling the robot arm using e.g. a joystick controller (whether or not as part of the calibration routine), or a combination of these. Trying to force the ballbar 10 beyond its normal range of travel is likely to lead to internal damage being caused to the ballbar 10, requiring expensive replacement and/or repair of the ballbar 10 and, possibly more significantly, causing disruption and delay to production procedures in the production facility in which the ballbar 10 is being used.

Accordingly, the present applicant has appreciated the desirability of producing a ballbar (or other type of length-measuring bar or measurement strut) that is more resilient to such adverse events as described above that will inevitably occur in practice and that may result in damage to the ballbar.

According to a first aspect of the present invention, there is provided a measurement strut for measuring a separation between two relatively moveable support members of a machine, the strut being removably couplable between the two support members and being adapted to become at least partially (or at least partly) decoupled from at least one of the support members when a compressive force developed in the strut by relative movement of the support members is greater than a predetermined threshold.

By becoming at least partially decoupled from at least one of the support members when a compressive force developed in the strut by relative movement of the support members is greater than a predetermined threshold, at least some of any excess relative movement of the support members towards each other can be absorbed, thereby helping to prevent damage being caused to the strut by adverse events such as those described above.

As an alternative (and generally equivalent) statement of the first aspect of the present invention, there is provided a measurement strut for measuring a separation between two relatively moveable support members of a machine, the strut being removably couplable between the two support members and being adapted to become at least partially (or at least partly) decoupled from at least one of the support members when relative movement of the support members attempts to operate the strut beyond a minimum end of a predetermined range of travel for the strut.

As an alternative (and generally equivalent) statement of the first aspect of the present invention, there is provided a measurement strut for measuring a separation between two relatively moveable support members of a machine, the strut being removably couplable between the two support members and comprising a coupling to at least one of the support members which is adapted to absorb at least some of any relative movement of the support members which attempts to operate the strut beyond a minimum end of a predetermined range of travel for the strut.

According to a second aspect of the present invention, there is provided a measurement strut for measuring a separation between two relatively moveable support members of a machine, the strut being removably couplable between the two support members and having a dedicated tether which is adapted catch the strut should it become decoupled from at least one of the support members.

The use of a dedicated tether feature will enable the strut to be caught should it become decoupled from the machine, thereby helping to prevent damage being caused to the strut.

According to a third aspect of the present invention, there is provided a measurement strut for measuring a separation between two relatively moveable support members of a machine, the strut being removably couplable between the two support members and being adapted to couple more strongly to one of the support members than the other.

The use of an asymmetric or unequal coupling strength enables the strut to remain coupled at one end even when it becomes decoupled at the other end, thereby preventing the strut from falling and being damaged. This feature also enables a calibration process to be more easily automated, without manual intervention being required, as will be described in more detail below.

The strut may be adapted to become at least partially decoupled from at least one of the support members when a compressive force developed in the strut by relative movement of the support members is greater than a predetermined threshold.

The strut may be adapted to become at least partially decoupled from at least one of the support members when relative movement of the support members attempts to operate the strut beyond a minimum end of a predetermined range of travel for the strut.

The compressive force developed in the strut by relative movement of the support members may become greater than the predetermined threshold when relative movement of the support members attempts to operate the strut beyond a minimum end of a predetermined range of travel for the strut.

The predetermined range of travel may be a range of travel beyond which the strut is likely to incur mechanical damage.

The predetermined threshold may be substantially independent of an angle of the strut relative to the relevant support member. In this respect, the angle which the strut makes relative to the relevant support member varies as the strut is moved around the working volume. The strut may be adapted such that the predetermined threshold is always (i.e. for any angle of the strut relative to the relevant support member) lower than a compressive force under which the strut is likely to incur mechanical damage, so that the strut will always become decoupled before it is damaged, regardless of angle. These considerations need only apply for any angle which is likely to be encountered during normal operation of the strut, i.e. for working or operational angles.

The support member may comprise a bearing surface and the strut may be provided with a coupling which is adapted to bear against and slide over the bearing surface of the support member.

The coupling of the strut may provide (or may be adapted to provide) a recess into which the bearing surface of the support member is received.

The coupling of the strut may have a generally concave or cup-shaped or female form. The bearing surface of the support member may have a generally convex or at least part-spherical or male form.

The bearing surface of the support member may be an at least part-spherical bearing surface, with the centre of the spherical part of the bearing surface defining or coinciding with a point of measurement for the strut when coupled to the support member.

The strut may be provided with a coupling which is adapted to bear against and slide over an at least part-spherical bearing surface provided on the machine, the centre of the spherical bearing surface defining a point of measurement for the strut.

The coupling may comprise a plurality of contact features which are raised or protrude above a surrounding surface of the coupling to form a coupling to the bearing surface.

The coupling may comprise three such contact features forming a kinematic or pseudo-kinematic coupling to the bearing surface.

The coupling may be adapted such that compressive forces developed in the strut during a relative movement of the two support members act on the bearing surface through the contact features of the strut coupling to create a net decoupling force.

The contact features may be arranged such that a contact angle for each contact feature may is above a predetermined threshold, for example above a friction angle. The contact angle may be defined as the angle between the force which acts through the contact feature and the inwardly-directed surface normal at the point of contact (between the contact feature and the support member).

The contact features may be arranged such that a coupling angle for the coupling is above a predetermined threshold. The coupling angle may be defined as the angle between a plane which contains the contact features (or the contact points created by the contact features on the support member) and a plane that is perpendicular to a longitudinal axis of the measurement strut.

During normal operation of the strut (i.e. when operated within the predetermined range of travel) the decoupling force may be lower than a coupling force which holds the strut to the bearing surface. The decoupling force may generally increase with an increasing compressive force developed in the strut until it overcomes the coupling force holding the strut, such that the strut becomes decoupled from the machine.

The coupling force may be a magnetic coupling force.

The surrounding surface (or an end surface of the strut) may be adapted such that, should any additional contact features (between the surrounding surface and the bearing surface) be created during the process of decoupling due to movement and/or rotation of the strut (i.e. before the strut fully decouples), the original contact features plus any such additional contact features still result in a net decoupling force that is sufficient to enable the decoupling process to be completed.

The strut may be (may have a coupling which) is adapted to absorb at least some of any relative movement of the support members which attempts to operate the strut beyond a minimum end of a predetermined range of travel for the strut.

The strut may be adapted to absorb at least some of such relative movement by partially decoupling from at least one of the support members, for example sliding along the support member.

The strut may be adapted to become fully decoupled from at least one of the support members when a compressive force developed in the strut by relative movement of the support members is greater than a predetermined threshold.

The strut may be a mechanical strut.

The strut may be a passive measurement strut (without internal drive means for extending and retracting the strut, requiring an external machine for this purpose).

The strut may comprise an encoder scale on one of two relatively moveable support members, and a readhead on the other of the two relatively moveable support members.

The separation measured by the strut may be a one-dimensional separation, a two-dimensional separation or a three-dimensional separation, preferably a one-dimensional separation.

According to another aspect of the present invention, there is provided a kit for characterising a machine, comprising a measurement strut according to any aspect of the present invention, and the support members to which the measurement strut is couplable, or at least any support member from which the measurement strut is adapted to become at least partially decoupled. In this respect, characterising the machine may comprise one or more of: calibrating the machine; verifying the machine; performing a health check of the machine; and setting up the machine.

According to another aspect of the present invention, there is provided a method of characterising a machine, comprising coupling a measurement strut according to any aspect of the present invention between the relatively moveable support members of the machine, controlling the machine to perform a sequence of movements, collecting measurement data from the strut during the sequence of movements, and using the collected measurement data to characterise the machine.

According to another aspect of the present invention, there is provided a method of characterising a machine, comprising coupling a measurement strut according to the third aspect of the present invention between the relatively moveable support members of the machine, controlling the machine to perform a sequence of movements, collecting measurement data from the strut during the sequence of movements, and using the collected measurement data to calibrate the machine, wherein the end having a stronger coupling is coupled to a moveable support member and the other end is coupled in turn to a plurality of fixed support members by controlling the machine to move the currently-active support members relative to one another so that, due to the different coupling strengths, the strut remains coupled to the moveable support member but becomes decoupled from the fixed support member, and then controlling the machine to move the strut, still coupled to the moveable support member, so as to couple to another of the fixed support members for performing further movements of the sequence.

A method of characterising the machine can be considered to be one or more of: a method of calibrating the machine; a method of verifying the machine; performing a health check of the machine; and setting up the machine.

The machine may comprise a coordinate positioning machine.

The coordinate positioning machine may comprise a non-Cartesian and/or parallel kinematic machine.

The coordinate positioning machine may comprise a robot arm.

The relatively moveable support members may be a fixed support member (e.g. supported on a machine base or a fixed platform) and a moveable support member (e.g. supported on an end effector or moveable platform of the machine).

The geometry of the machine may be characterised by a set of model parameters and calibrating the machine may comprise determining a new set of model parameters that characterises the geometry of the machine better than an existing set of model parameters.

According to another aspect of the present invention, there is provided a machine controller configured control a machine to perform a method according to any aspect of the present invention.

According to another aspect of the present invention, there is provided a computer program which, when run by a computer or a machine controller, causes the computer or machine controller to perform a method according to any aspect of the present invention. The program may be carried on a carrier medium. The carrier medium may be a storage medium. The carrier medium may be a transmission medium.

According to another aspect of the present invention, there is provided a computer-readable medium having stored therein computer program instructions for controlling a computer or machine controller to perform a method according to any aspect of the present invention.

It is to be noted that the term “measurement strut” is used herein in connection with an embodiment of the present invention, rather than the term “ballbar” as used above with reference to FIGS. 2 and 3. However, these terms can be considered in general to be functionally equivalent. A ballbar such as the QC20-W from Renishaw plc is designed to be highly accurate over a relatively short range of measurement, being based on a capacitive measurement transducer system. When used in a method of calibrating a robot arm, it can be useful to have a wider range of measurement and/or travel, in order to accommodate the greater range and type of motion associated with such machines, and the term “measurement strut” rather than “ballbar” is used in this context merely as a convenience. However, it is to be noted that a measurement strut embodying the present invention is not limited to any particular range of measurement or travel, or any particular method of measuring changes to the length of the measurement strut (e.g. capacitive vs encoder).

Reference will now be made, by way of example, to the accompanying drawings, in which:

FIG. 1, discussed hereinbefore, is a schematic illustration of a coordinate positioning arm in the form of an articulated robot;

FIG. 2, also discussed hereinbefore, illustrates a method of using a ballbar to perform calibration of an articulated robot of a type shown in FIG. 1;

FIG. 3, also discussed hereinbefore, illustrates another method of using a ballbar to perform calibration of an articulated robot of a type shown in FIG. 1;

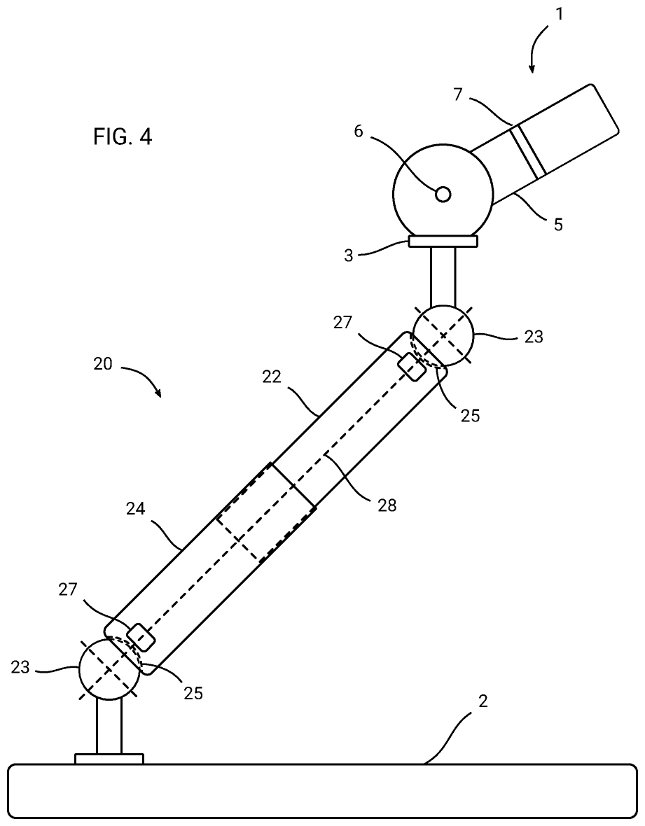

FIG. 4 is a schematic illustration of a previously-considered type of measurement strut coupled between two support members of a machine;

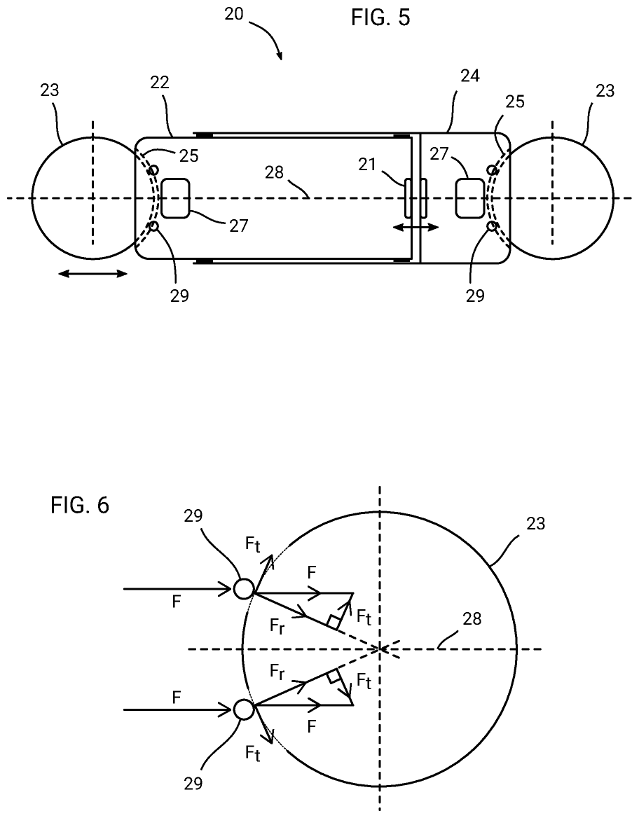

FIG. 5 is a more compact schematic representation of the measurement strut of FIG. 4, also showing some more internal detail;

FIG. 6 is a schematic illustration of forces associated with the coupling arrangement used in the measurement strut of FIG. 5;

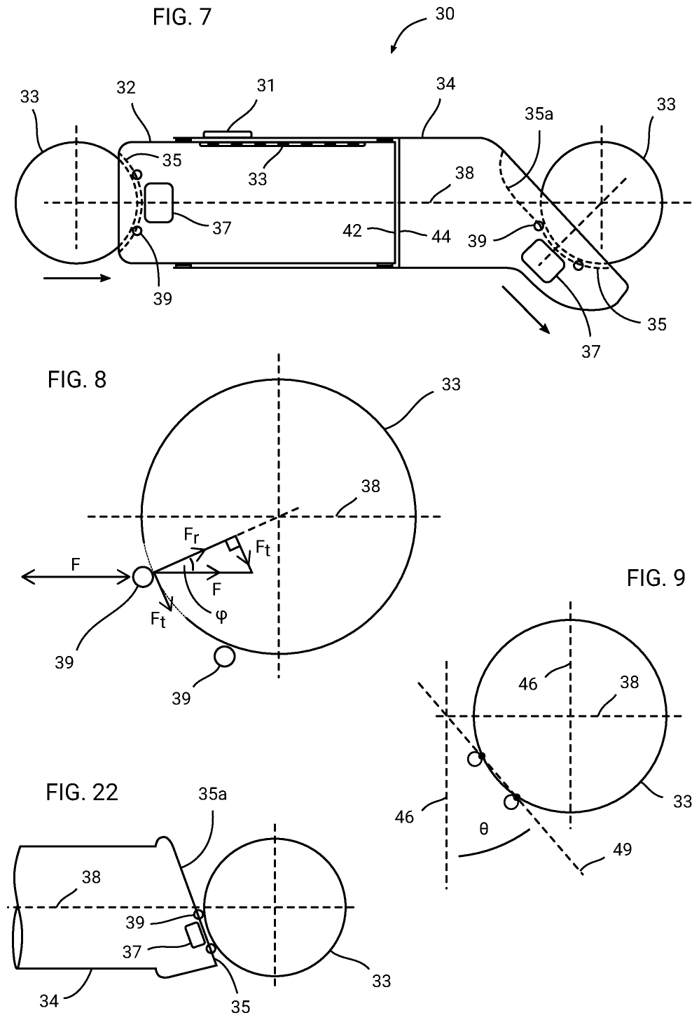

FIG. 7 is a schematic illustration of a measurement strut according to an embodiment of the present invention, presented in a form equivalent to that of FIG. 5;

FIG. 8 is a schematic illustration of forces associated with the coupling arrangement used in the measurement strut of FIG. 7;

FIG. 9 illustrates an angle of a plane containing the contact points created by the coupling features of the strut, and how this can be used as a design parameter for the coupling;

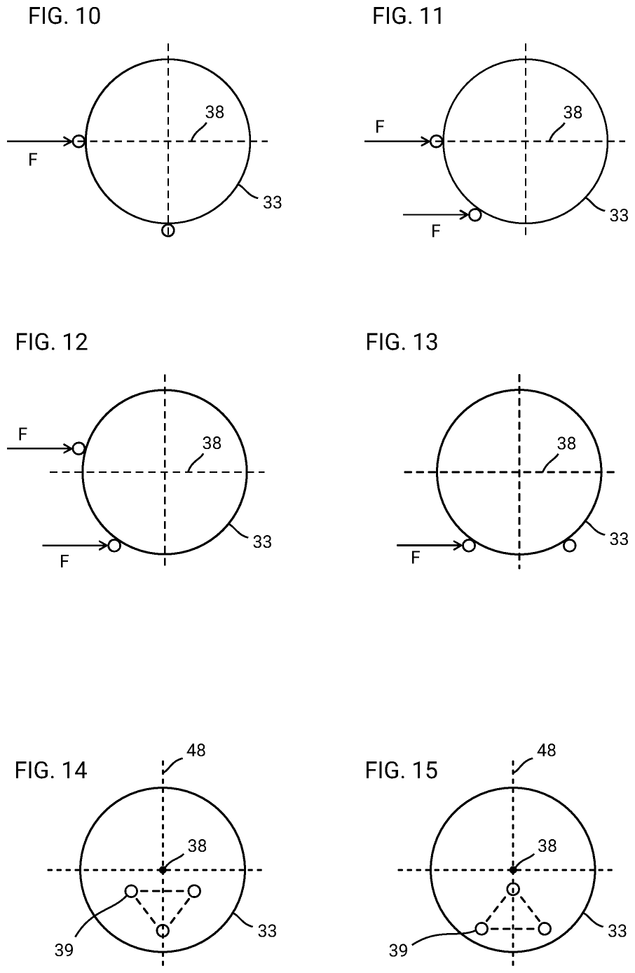

FIGS. 10 to 13 are schematic illustrations providing further insight concerning what does and does not constitute an embodiment of the present invention;

FIG. 14 is a schematic illustration of one possible arrangement of the three contact points of the strut coupling feature, as viewed along the longitudinal axis of the strut;

FIG. 15 is a schematic illustration of an alternative arrangement of the three contact points of the strut coupling feature, as viewed along the longitudinal axis of the strut;

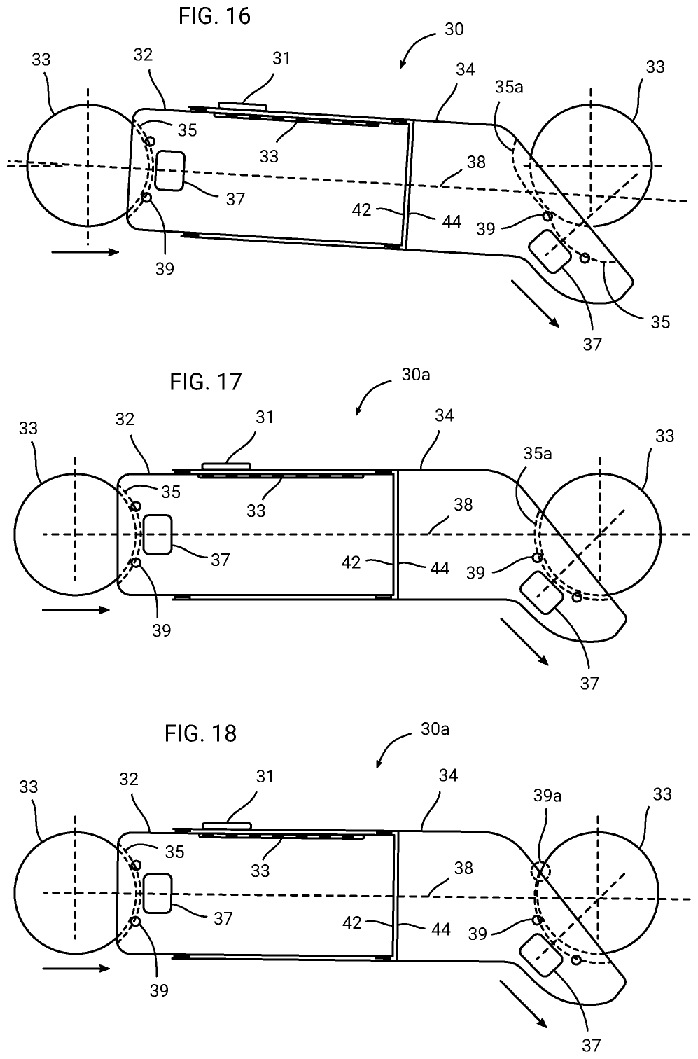

FIG. 16 is a schematic illustration of the strut of FIG. 7 in a partially decoupled state;

FIG. 17 is a schematic illustration of a strut having a different form of end surface compared to that of FIG. 7;

FIG. 18 shows the strut of FIG. 17 in a partially decoupled state in which an additional contact feature has been created which prevents a full decoupling;

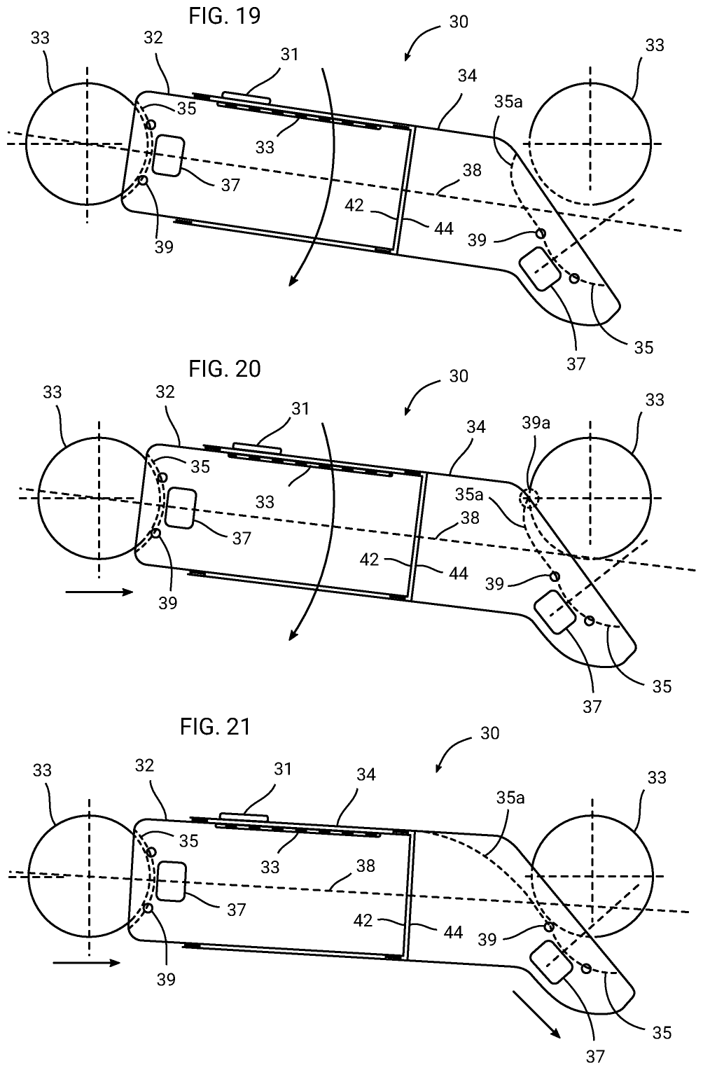

FIG. 19 shows the strut of FIG. 7 in a fully decoupled state;

FIG. 20 shows the strut of FIG. 7 in a partially decoupled state in which an additional contact feature has been created which prevents a full decoupling;

FIG. 21 is a schematic illustration of a strut having a different form of end surface compared to that of FIG. 7;

FIG. 22 is a schematic illustration of a strut having a different form of end surface compared to that of FIGS. 7 and 21;

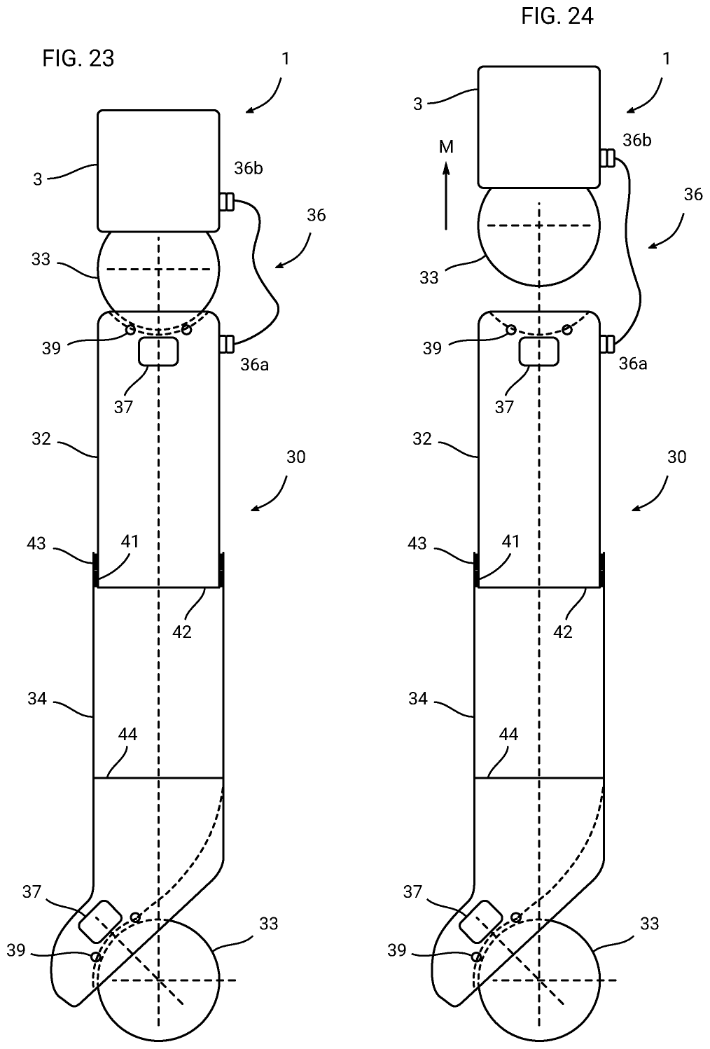

FIG. 23 is a schematic illustration of a measurement strut having a dedicated tether feature;

FIG. 24 shows the measurement strut of FIG. 23 having decoupled from the machine at its upper end but caught by the tether feature;

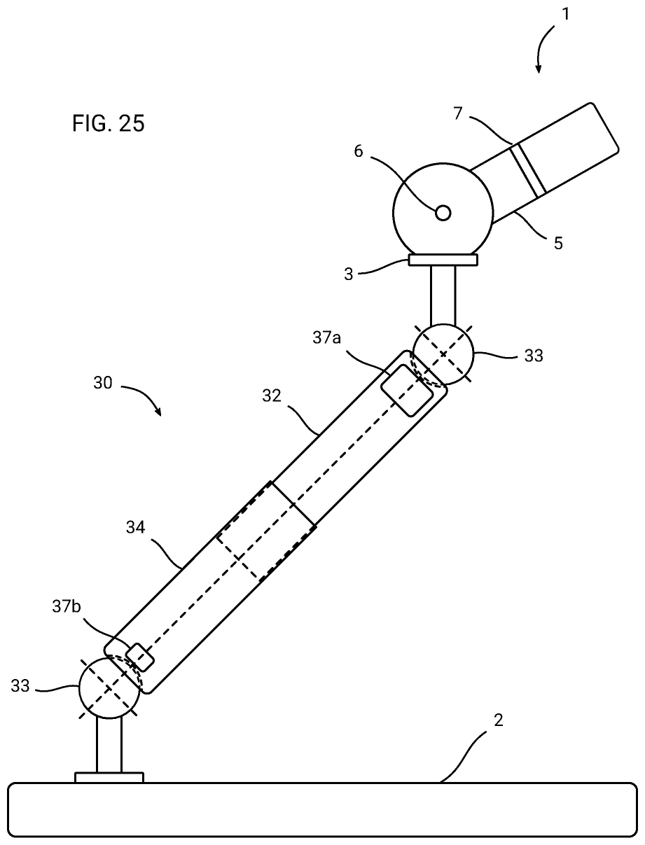

FIG. 25 is a schematic illustration of a measurement strut having an asymmetric coupling strength feature; and

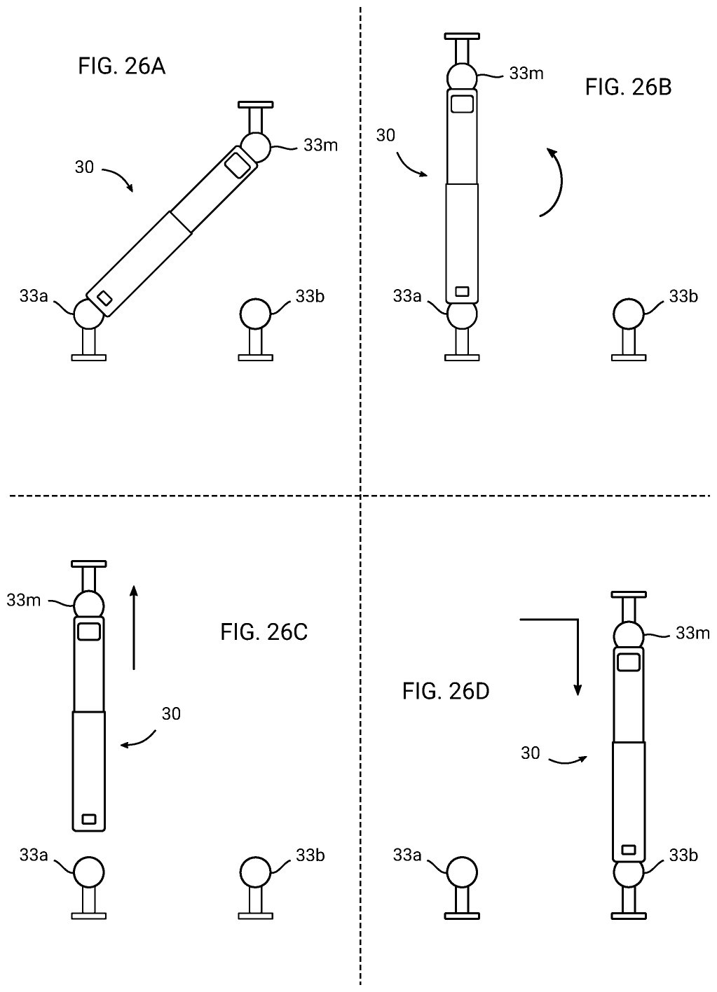

FIGS. 26A to 26D illustrate use of the asymmetric coupling strength feature to as part of a machine calibration method.

A previously-considered type of measurement strut 20 is shown schematically in FIG. 4. The measurement strut 20 is illustrated as being coupled between two support members 23. The support members 23 are moveable relative to one another by a coordinate positioning machine, with the coordinate positioning machine in this example being a robot arm 1 like that described above with reference to FIGS. 1 to 3, having a flange 3 moveable by a series of rotary joints 6, 7, and with the first support member 23 being fixed to the flange 3 via a stem. The measurement strut 20 itself has a first member 22 (in the form of a tube) which slides telescopically within a second member 24 (also in the form a tube).

FIG. 5 is a more compact schematic representation of the measurement strut 20 of FIG. 4, showing more clearly how the measurement strut 20 is adapted to couple with the support members 23. The support members 23 are generally spherical, for example each in the form of a ball, each having an at least part-spherical convex bearing surface to which the measurement strut 20 is adapted to couple. Each end of the measurement strut 20 is provided with a coupling feature 25 having a generally concave or cup-shaped form, corresponding inversely in shape to that of the convex or spherical (ball-shaped) bearing surface of the support member 23 to which it is coupled. In this way, the coupling feature 25 is adapted to provide a recess into which the bearing surface of the support member 23 is received in a male/female type of coupling arrangement. The coupling feature 25 of the strut 20 provides the female side of the coupling arrangement while the support member 23 of the machine 1 provides the male side of the coupling arrangement, with the male part being received into the female part when coupled.

Rather than have the support member 23 bearing directly onto the surface within the coupling feature 25, creating a surface-to-surface contact, discrete contact features can be provided within the coupling feature 25 in order to create a more point-like contact. Accordingly, FIG. 5 shows that the coupling feature 25 in this embodiment is provided with three contact features 29, so that the support member 23 sits against these contact features 29, thereby creating a surface-to-point contact in three places. The contact features 29 protrude from the underlying surface, thereby forming protrusions, and can conveniently be provided by three small balls embedded into the underlying surface. The three points of contact created by these contact features 29 create a kinematic form of coupling, enabling the support member 23 to sit within the corresponding coupling feature 25 in a known and repeatable position each time the measurement strut 20 is coupled to the machine. Furthermore, assuming that the bearing surface of the support member 23 is precisely spherical, the measurement strut 20 will advantageously rotate precisely around a fixed point (i.e. the centre of the spherical bearing surface of the support member 23), which would not be the case with a non-kinematic form of coupling in which there would be over-constraint and corresponding positional uncertainty associated with the coupling (due to multiple possible resting positions). In practice, the support member 23 will contact each of the contact features 29 over a small surface area, rather than at a singular point, so that the coupling can be considered to be “pseudo-kinematic” rather than perfectly kinematic, but kinematic design principles can still be considered to apply. It will also be appreciated that, due to the presence of the contact features 29 within the coupling feature 25, the inner surface of the coupling feature 25 need not have a concave spherical form but could e.g. be flat, because contact with the support member 23 is via the contact features 29 and not the surface surrounding the contact features 29.

The support members 23 are advantageously formed at least partly of a magnetic material (e.g. a ferrous metal), with magnets 27 being provided at each end of the measurement strut 20 as part of or in close proximity to the coupling features 25, so that the measurement strut 20 is thereby held in place (at least partly) by the resulting attractive magnetic force acting between the measurement strut 20 and the support members 23. A spring or other form of resilient member could be used instead of a magnet to create an attractive holding or coupling force.

As shown in FIG. 5, the measurement strut 20 in this example has a capacitive measurement sensor 21, which relies on measuring changes in a capacitance between two plates that are in close proximity to one another and that move respectively with the first and second members 22, 24 of the measurement strut 20. It can also be observed that the measurement strut 20 is generally functionally equivalent to the ballbar 10 described above with reference to FIGS. 2 and 3, though the coupling arrangement is reversed, with the support members 23 on the machine being ball-shaped and the coupling features 25 on the measurement strut 20 coupling being generally cup-shaped, rather than the other way round.

In order to create a secure and stable coupling, it is normal to arrange the contact features 29 (or kinematic coupling features) symmetrically about a longitudinal axis 28 of the measurement strut 20. As shown in FIG. 6, when a compressive force F is developed within the strut by driving the support members 23 towards each other, there is a corresponding force F acting through each contact feature 29 on the spherical bearing surface of the support member 23. This force F can be resolved into two orthogonal components Fr and Ft, respectively acting radially and tangentially on the spherical bearing surface. Because the contact features 29 are disposed symmetrically about the longitudinal axis 28 of the measurement strut 20, the forces are balanced and there is a net-zero force acting in a direction perpendicular to the longitudinal axis 28. Accordingly, there is no tendency for the measurement strut 20 to move sideways, i.e. in a direction perpendicular to the longitudinal axis 28, and the measurement strut 20 is retained stably on the support member 23. This is conventionally considered to be desirable, because the coupling is stable (and self-stabilising).

FIG. 7 is a schematic illustration of a measurement strut 30 according to an embodiment of the present invention, coupled between support members 33 of a coordinate positioning machine such as a robot arm 1. Most parts shown in FIG. 7 correspond generally to equivalent parts shown in FIG. 5, with reference numerals of like parts differing by 10 (e.g. strut member 24 of FIG. 5 is generally equivalent to strut member 34 of FIG. 7, and similarly for support members 23 and 33 of FIGS. 5 and 7 respectively). Accordingly, a detailed description any common components is not required.

The measurement strut 30 of FIG. 7 differs from the measurement strut 20 of FIG. 5 in that changes in strut length are measured by use of an encoder scale 33 disposed on the first strut member 32, paired with a readhead 31 arranged on the second strut member 24. As the separation between support members 33 changes, with a corresponding change in length of the strut 20, the first strut member 32 will slide relative to the second strut member 24 and this movement will be measured by the readhead 31 moving over the encoder scale 33. Such a measurement arrangement, making use of a readhead 31 and a length of encoder scale 33, can typically offer a greater range of measurement than the capacitive sensor arrangement 21 shown in the strut 20 of FIG. 5.

More significantly, however, the measurement strut 30 of FIG. 7 differs from the measurement strut 20 of FIG. 5 in the coupling arrangement between the measurement strut 30 and the support members 33 of the machine. With the measurement strut 30 of FIG. 7, the contact features 39 (or kinematic coupling features) at one end are deliberately arranged to one side of the longitudinal axis 38 of the measurement strut 30, i.e. below the longitudinal axis 38 in the schematic view as shown in FIG. 7. When considered as a group, the contact features 39 are therefore offset from the longitudinal axis 38 rather than being coincident with it.

The effect of this is shown in the force diagram of FIG. 8, which is equivalent to that of FIG. 6. When a compressive force F is developed within the strut by driving the support members 33 towards each other, there is a corresponding force F acting through each contact feature 39 (contact point) on the spherical bearing surface of the support member 33. Because the contact features 39 are no longer disposed symmetrically about the longitudinal axis 38 of the measurement strut 30, the forces no longer balance as they did with FIG. 6. The tangential component Ft of force F acts sideways, but there is no longer a balancing or counteracting force Ft from a contact point on the other side of the longitudinal axis 38. The lower contact feature 39 is not shown in FIG. 8 as having any effect because in practice, as soon as the end of strut 30 starts to move sideways, this will be realised as a rotation of the strut 30 around the other end, and this will in turn cause the lower contact feature 39 to lift away from the surface of the support member 33 so that only the upper contact feature 39 remains in contact.

For low values of force F, the tangential component Ft of force F will be insufficient to overcome any attractive force from the magnet 37, so that the measurement strut 30 will remain in place. However, as the compressive force F developed in the measurement strut 30 increases, the tangential component Ft of force F will eventually become sufficient to overcome any attractive force from the action of the magnet 37, so that the end of measurement strut 30 will be caused to move sideways (normal to the longitudinal axis 38) and may become decoupled from the support member 33.

A strut coupling arrangement according to an embodiment of the present invention is therefore deliberately designed to have a natural destabilising effect, which is contrary to normal practice in this field. During normal use of the measurement strut 30, a moderate increase in the compressive force F developed in the measurement strut 30 will be caused for example by acceleration of one support member 33 toward the other. It is of course desirable that the measurement strut 30 does not become decoupled from the machine during normal use, so the magnetic coupling effect and the decoupling effect described above can be set relative to one another so that compressive forces which typically occur during normal use will be insufficient to cause the strut 30 to become decoupled from the support member 33.

A more significant increase in the compressive force F developed in the strut 30 will be caused by a relative movement of the support members 33 toward one another beyond a normal or intended range of travel for the strut 30. For example, if a stop member 42 of the first strut member 32 is moved up against a corresponding stop member 44 of the second strut member 34, as illustrated in FIG. 7, then any additional relative movement of one support member 33 toward the other will lead to a rapid and significant compressive force F being developed in the strut, likely leading to internal damage without preventative measures. However, the magnetic coupling effect and the decoupling effect can be controlled or balanced relative to one another so that compressive forces which typically occur during such an adverse event will be sufficiently great to cause the strut 30 to become decoupled from the support member 33 before any damage is caused to the strut 30.

Referring to FIG. 9, it is useful to consider a plane 49 which contains the contact features 39, or the contact points created by the contact features 39 on the support member 33, and to specify a suitable value for an angle θ that this plane 49 makes with a plane 46 that is perpendicular to the longitudinal axis 38 of the measurement strut 30. This angle θ, which is referred to herein (including in the appended claims) as the coupling angle, can be considered to be a design parameter for the measurement strut 30. For the coupling arrangement of FIG. 5, the plane 49 is arranged so as to be exactly normal to the longitudinal axis 28 of the strut 20, i.e. so that the coupling angle θ is 0°. However, for the strut 30 embodying the present invention, a non-zero coupling angle θ is used. A suitable value for the coupling angle θ in one particular implementation was determined to be 20°, for the particular strength of magnet 37 used, since it was found experimentally that this resulted in the strut 30 always becoming decoupled from the support member 33 before damage was likely to result, but not too soon that the strut 30 became decoupled too easily.

However, it is to be understood that there is no limitation intended by this particular example, with any angle being suitable if it leads to disengagement of the strut before the compressive force becomes sufficiently great to risk causing internal damage to the strut. It is a relatively trivial design task to determine appropriate design parameters for the strut, taking into account for example the materials used and the smoothness of the relevant bearing surfaces, to achieve the aim of ensuring that the strut 30 becomes decoupled before damage is likely to be incurred. For example, the angle θ as described above, and as illustrated in FIG. 9 can be used as a design parameter which can be modified to determine the effect it has on the decoupling behaviour. Mathematical modelling could also be employed to determine appropriate parameters. The angle θ can be decreased by moving the contact features 39 closer to the axis 38, and conversely increased by moving the contact features 39 further away from the axis 38. The diameter of the spherical support member 33 can also be used as a design parameter for the coupling, because this can also be used to control where the axis 38 lies relative to the geometrical centre of the spherical support member 33 when all three contact features 39 are in contact with the spherical support member 33.

To form a better understanding of what coupling arrangements are considered to be suitable for use in an embodiment of the present invention and which are not, reference will now be made to the examples shown in FIGS. 10 to 14.

With the arrangement shown in FIG. 10, one of the contact features 39 is arranged exactly on the longitudinal axis 38 while the other contact feature 39 is arranged exactly on a plane that passes through the geometrical centre of the spherical support member 33 and which is perpendicular to the axis 38. In this case, the lower contact feature 39 has no decoupling effect because the entire force F acts tangentially (Ft) without any radial force component (Fr) to apply a sideways moment to the strut 30. Similarly, because the upper contact feature 39 is exactly on axis 38, the entire force F acts radially (Fr) without any tangential force (Ft) to apply a sideways moment to the strut 30.

Even if the upper contact feature 39 of FIG. 10 is, due to manufacturing tolerances, inadvertently located very slightly off axis 38, it will still not in practice produce a decoupling effect as required by the present invention because of friction. The concept of a “friction angle” can be a useful design consideration here. Referring to FIG. 8, consider the angle φ formed between the force F and the radial component Fr (which is also the angle formed between the force F and the inwardly-directed surface normal at the point of contact). This angle φ, which is referred to herein (including in the appended claims) as the contact angle, needs to be above a certain threshold angle before friction acting between the contact feature 39 and the bearing surface can be overcome. The threshold angle is referred to herein as the “friction angle”. If the contact angle φ is below the threshold angle (friction angle) then friction will prevent the contact feature 39 from sliding along the bearing surface, while if the contact angle φ is above the threshold (friction angle) then the tangential force component Ft will be sufficient to overcome the effect of friction and the contact feature 39 will be caused to slide along the bearing surface of the support member 33. However, so far as the overall decoupling effect is concerned, there is a balance to be achieved. On the one hand, the tangential force component Ft increases as the contact feature 39 moves further away from the axis 38. On the other hand, when considering a constant force acting tangentially, the destabilising effect of such a force will decrease as the contact feature 39 moves further away from the axis 38 (because less of the force is acting perpendicular to the axis 38).

Therefore, the arrangement shown in FIG. 10 does not constitute an embodiment of the present invention. Similar considerations apply to the arrangement illustrated in FIG. 11. Although one might consider that the lower contact feature 39 will produce a decoupling force, in practice the upper contact feature 39 will not slide for the same reasons as described above with reference to FIG. 10, despite any possible tangential force contribution from the lower contact feature 39. In any case, any small sliding movement will lift the lower contact feature 39 off the bearing surface (due to rotation of the strut 30 around the other end) so that it no longer has any effect.

Despite an asymmetrical arrangement around the axis 38, the arrangement of FIG. 12 also does not constitute an embodiment of the present invention because the upper contact feature 39 is the other side of the axis 39 compared to the lower contact feature 39. Therefore, one of the contact features 39 would need to move “uphill” in complete opposition to the direction of the applied force F, which is not possible. Eventually, some form of equilibrium will be reached with FIG. 12, so that the strut 30 will remain coupled even as increasing force F is applied, eventually leading to damage.

Finally, the arrangement of FIG. 13 does constitute an embodiment of the present invention because the left-hand contact feature 39 will cause a decoupling effect for the same reason as explained with reference to FIG. 8, while the right-hand contact feature 39 will not have any effect. With the arrangement of FIG. 13 the support member 33 would effectively be coupling to the side of the strut 30, and this would function effectively so long as the magnetic coupling force described above is sufficient to hold the strut 30 in place.

Purely as general guidance, and not to imply any limitation to the scope of the present invention as set out in the appended claims, a suitable value for the coupling angle θ (as defined above) is in the range 5° to 90°, more preferably in the range 8° to 60°, more preferably in the range 12° to 45°, more preferably in the range 15° to 30°, more preferably in the range 18° to 24°, and more preferably approximately 20°. A suitable value for the contact angle φ (as defined above) for at least the contact feature (e.g. contact feature 39) that remains in sliding contact with the bearing surface of the support member 33 as the strut 30 is in (or begins) the process of decoupling from the support member 33 is anything below 90° and above the friction angle associated with sliding contact between that contact feature and the bearing surface, more preferably in a range between 5° above the friction angle and 70°, more preferably in a range between 10° above the friction angle and 60°, and more preferably in a range between 15° above the friction angle and 50°. Alternatively, a suitable value for the contact angle φ can be considered to be in a range between 5° and 70°, more preferably in a range between 10° and 60°, and more preferably in a range between 15° and 50°.

The schematic illustrations discussed above are two-dimensional schematic representations of the coupling arrangement, showing just two contact features 39 for the sake of simplicity, while in practice there would be three contact features 39 to form a kinematic coupling with the support member 33. FIG. 14 is a schematic illustration of one possible arrangement of these three contact features 39, relative to the support member 33, as viewed along the longitudinal axis 38 of the strut 30. With such a triangular arrangement of contact points 39, a pair of contact points 39 is disposed symmetrically about a plane 48 passing through the longitudinal axis 38 of the triangle, with the remaining (single) contact point 39 being on the plane 48. The pair of contact points 39 are arranged closer to the axis 38 than the remaining (single) contact point 39.

An alternative arrangement of the three contact features 39 is shown in FIG. 15, with the triangular arrangement effectively being upside down compared to FIG. 14, such that the single contact point 39 is now closer to the axis 38 than the pair of contact points 39. Either arrangement (FIG. 14 or 15) would be suitable, but the arrangement of FIG. 14 is likely to be preferable because two contact features 39 will remain in contact with the support member 33 as the strut 30 is in the process of decoupling from the support member 33, leading to a more predictable and controlled decoupling, without any tendency for the strut 30 to twist or rotate around its longitudinal axis 38 (as would also tend to happen if the triangular arrangement of contact points 39 were not symmetrical about the plane 48).

It is apparent from FIG. 7 that the inner surface of the coupling feature 35 at the right-hand end of the measurement strut 30 (i.e. the end having the offset coupling arrangement) has a shape which corresponds closely to the support member 33 to which the measurement strut 30 is coupled, creating a substantially constant gap, at least in a region between the contact features 39 and to the right of the right-most contact feature 39 (further from the axis 38). This enables the magnet 37 to sit closely to the support member 33, thereby creating a strong magnetic coupling force. However, to the other side of the contact features 39 (closer to the axis 38) the inner surface 35a of the coupling feature 35 is profiled such that a gap is opened up between the inner surface 35a and the support member 33. This is to ensure that, when the measurement strut 30 is in the process of decoupling (i.e. has started sliding along but is still in contact with and has not yet become detached or decoupled from the support member 33), any additional contact created during decoupling also satisfies the relevant criteria or guidance set out herein.

In this respect, FIG. 16 shows the measurement strut 30 when the upper or inner-most contact feature 35 (or the upper or inner-most pair of contact features 35 as shown in FIG. 14) has already slid part way along the bearing surface of the support member 33, and has reached a position where it is about to decouple from the support member 33 (when the magnetic coupling force from the magnet 37 is no longer sufficient to hold the strut 30 on the support member 33 against gravity). In the state shown in FIG. 16, the strut 30 can be described as being partially or partly decoupled, because the original contact features 39 are no longer all fully coupled to (touching or bearing onto) the support member 33, but the strut 30 is still in contact with the support member 33 in some sense (in this example via just one or a pair of the contact features 39). In the example shown, no additional contact is created by the inner surface 35a before this decoupling occurs, so the decoupling behaviour is dictated solely by the interaction between the contact features 35 and the bearing surface of the support member 33. However, it could also be that the surrounding inner surface 35a does come into contact with the support member 33 before decoupling occurs, so long as any such additional contact can also continue to slide without becoming snagged (and thereby preventing the strut 30 from becoming fully decoupled).

FIG. 17 shows an example measurement strut 30a where the inner surface 35a follows the spherical profile of the support member 33 over substantially its entire extent, with a substantially constant gap throughout. This is still potentially a valid arrangement, so long as there is sufficient clearance between the inner surface 35a and the support member 33 as the strut 30a is decoupling so that, if there is an additional contact created, this additional contact does not cause snagging (for example if the contact angle is above the friction angle described above). However, if as shown in FIG. 18 there is insufficient clearance, an additional contact feature 39a may be created, before the magnetic coupling has weakened sufficiently to release the 30a from the support member 33, and this snagging contact feature 39a will prevent the strut 30a from decoupling. Any further relative movement of the support members 33 towards one another will potentially result in damage being caused to the strut 30a.

Returning to FIG. 16, it is noted that if the right-hand end of the strut 30 falls away from the support member 33 without much (or without any) further relative movement of the support members 33 towards one another, the left-hand end of the strut 30 will remain coupled to the left-hand support member 33, so that the strut 30 will rotate clockwise around the left-hand support member 33. This is shown in FIG. 19, in which the strut 30 is now in a fully decoupled condition without any contact at the decoupled end between the strut 30 and the support member 33. With the form of inner surface 35a as illustrated, the strut 30 is able to fall away (decouple) completely from the machine under gravity, without any further contact with the right-hand support member 33. This is also the case if there is further relative movement of the support members 33 towards each other, but insufficiently rapid to cause the strut surface 35a to remain in contact with the support member 33 as the strut 30 falls away under gravity. However, if there is a more rapid relative movement of the support members 33 towards each other, so that the strut surface 35a remains in contact with the support member 33, then there is the potential for a snagging contact feature 39a to be created in a similar way to FIG. 18. However, even with this form of strut end surface 35a some benefit has been achieved compared to a strut 20 like that of FIG. 5, because at least some of the relative movement of support members 33 towards each other (after the strut reached a minimum end of its range of travel) has already been absorbed by the offset coupling feature. The excess travel has been absorbed by the strut 30 moving from a fully coupled state to a partially decoupled (or partially coupled) state, even though a further (full) decoupling of the strut 30 may be prevented as shown in FIG. 20. Also, a rapid relative movement between support members 33 may help in some situations if this causes the strut 30 to be flung sideways, without the assistance of or even against gravity, and away from any danger of further snagging with the support member 33.

Preferably, however, the profile of the inner surface 35a should be shaped so that it will not cause snagging for any machine movement (regardless of speed of relative movement between support members 33) and for any strut orientation (so that gravity need not be relied upon to draw the strut 30 away from the support member 33 before a situation like that of FIG. 20 is reached). An example of such a profile for the inner surface 35a is illustrated schematically in FIG. 21. The inner surface 35a is shaped so that any additional contact feature created during the process of decoupling (when the strut 30 is still in a partially coupled state) will move more slowly around the bearing surface of the support member 33, and in addition because the strut 30 is all the time rotating further around the other support member 33, the compressive force F through the additional contact will become more of a glancing contact, so that the contact angle (defined above) remains above the threshold angle (e.g. friction angle), and such that a full disengagement or decoupling of the strut 30 can occur, without any snagging contact 39a being created.

Many other possible designs for the coupling feature 35 would be readily apparent to the skilled person. For example, FIG. 22 shows as relatively simple form of coupling feature 35, having contacts features 39 arranged with a coupling angle (as defined above) of 20°, and with a substantially planar end surface 35a, even between and to the outer side of the contact features 39. As is apparent from this embodiment, the coupling feature 35 does not need to have any part which can be said to have a cup or concave shape corresponding to the spherical surface of the support member 33, because the coupling is defined only by the contact features 39. The inner-most contact feature or features 39 are relatively close to the axis 39, so that their contact angle (as defined above) is relatively small, but with suitable materials having a low sliding friction (and consequently a low friction angle) this has been found to function well in practice. Furthermore, should the flat surface 35a make contact with the support member 33 during a decoupling operation, thereby creating an additional contact feature (or contact point), the contact angle associated with this additional contact feature will still above the threshold (friction angle) so that the strut will continue to slide off the bearing member 33 if compressive force F in the strut is maintained or increased, thereby completely decoupling the strut from the machine before damage is done to it. It is noted that the longer the strut 30 is relative to its width, the smaller its angle of rotation will be around the far end of the strut for the same lateral displacement on the bearing member 33 at the near end (i.e. the decoupling end). Therefore, the change in angle of the planar surface 35a will be small during a decoupling operation, so that the point of contact between the planar surface 35a and the spherical surface of the support member 33 will remain fairly static as the two support members 33 are driven towards each other, and in particular will not move around the surface to a position where it may start to cause snagging (as per the examples shown in FIG. 18 or FIG. 20). Therefore, a curved surface 35a like that shown in FIG. 21 is not necessary and a flat surface 35a like that shown in FIG. 22 will suffice.

A measurement strut embodying the present invention is preferably a passive measurement strut, meaning that it has no actuator or motor or other means for extending and retracting itself. The strut is purely a measurement strut, not a drive strut or even a combined drive and measurement strut. Instead, the measurement strut is intended to be connected to a separate and independent machine having its own drive means (such as the robot arm 1 described above), with the strut passively measuring a separation between two parts of the machine. The compressive force developed in the strut, as described above, is generated by movement of the external machine and by the machine acting externally on the strut to apply a compressive force thereto. This creates a decoupling force by action on the bearing surface of the support member, causing the strut to decouple from the machine.

For example, it would not be apparent to the skilled how the present invention would be of benefit in the context of a hexapod machine having six active (driven) struts connected in a hexapod arrangement between two relatively moveable platforms (such as is described for example in WO 2017/021733). This is because the platforms are not spatially constrained relative to one another, except via the active struts, so that when for example the struts are extended, thereby developing a compressive force within the struts at least during such movement, the compressive force would never be sufficient to cause internal damage to the strut. Furthermore, if an offset strut coupling arrangement as described above were used, so that the one or more struts does become decoupled if (for example) the moving platform comes up against an unexpected obstruction, the platform would no longer be fully support and would itself then likely fall to the machine bed, causing damage to the platform and to any tool or measurement probe supported thereon, which would be just as undesirable if not more so than causing damage to the strut itself.

It will be appreciated that an offset coupling arrangement as set out above could be provided at both ends of the strut. It is also to be noted that the support member should normally be considered to include not only that part which actually forms the spherical bearing surface, but also any ancillary rigid fixing member which is used to hold the bearing surface relative in a fixed relationship to the machine or the machine base, as the case may be. For example, it is not sufficient if the strut becomes decoupled from the ball (defining the bearing surface) only to be caught on a rigid stem that connects the ball to the machine, so that further relative movement of the support members is still likely to cause damage. The strut may be considered to be “decoupled” from the support member when the compressive force (that might otherwise cause damage to the strut) is released, and/or when further relative movement of the support members does not lead to a potentially damaging compressive force to be developed again within the strut (within reasonable limits, for example a further movement within or of the order of a distance that is comparable to a representative dimension of the support member, such as the diameter of the spherical bearing surface).

As described above, a measurement strut embodying the present invention is specifically adapted to become at least partially decoupled from at least one of the support members when a compressive force developed in the strut by relative movement of the support members is greater than a predetermined threshold. In this way, at least some of any excess relative movement of the support members towards each other can be absorbed, thereby helping to prevent damage being caused to the strut by attempting to compress the strut beyond its normal range of travel. An embodiment of the present invention is to be contrasted with an arrangement as shown for example in FIG. 2 in which the strut 10 would likely become decoupled if the moveable mount 14 is driven towards the fixed mount 12, but only because the strut 10 happens to be at an extreme angle relative to the mount 14; at other angles, such as shown in FIG. 3, this would not be the case. With a measurement strut according to an embodiment of the present invention, the above-mentioned threshold (above which the strut is adapted to become at least partially decoupled from at least one of the support members) is preferably substantially independent of an angle which the strut makes relative to the relevant support member as the strut is moved around the working volume (supported between the support members) or at least (for any such angle) remains below a compressive force under which the strut is likely to incur mechanical damage; this is not the case with the arrangement of FIG. 2.

The above embodiments can be considered to relate to a first aspect of the present invention. An embodiment of a second aspect of the present invention will now be described with reference to FIGS. 23 and 24, which show a measurement strut 30 coupled between two support members 33 of a machine. This embodiment is based very closely on the above-described embodiments relating to the first aspect, with like reference numerals referring to like parts so that a further description of these like parts is not required. The strut 30 of FIGS. 23 and 24 differs from earlier embodiments by being provided with a tether 36 which is connected in use between the strut 30 and the machine, for example between the strut 30 and an end effector 3 of a robot arm 1.

The tether 36 of FIGS. 23 and 24 is provided to solve a problem identified by the present applicant, which is related to the problem associated with the first aspect of strut damage caused by machine movements beyond the minimum travel range of the strut. In this respect, the present applicant has appreciated that, particularly for larger-scale movements of robot arms like those described with reference to FIG. 3, there is also a risk of strut damage being caused by machine movements beyond the maximum travel range of the strut. This potential problem can be described with reference to FIG. 23, which shows stop members 41 and 43 associated respectively with the first and second strut members 32 and 34. In the configuration shown in FIG. 23, strut 30 has been extended to its maximum extension, which happens when stop member 41 has reached stop member 43, thus preventing further extension. From the state as shown in FIG. 23, if the support member 33 attached to end effector 3 is moved any further away from the support member 33 at the other end of the strut 30, the inevitable outcome is that the strut 30 becomes decoupled from the machine, either at the top end or the bottom end. Becoming decoupled at the bottom end is not typically a problem, because the strut 30 remains supported by machine via the upper support member 33. However, becoming decoupled at the top end is a problem because the strut 30 will then be free to fall under gravity to the machine table 2, with likely damage being caused.

Therefore, the present applicant has devised a novel solution to the above-mentioned problem, which is to provide the strut 30 with a dedicated tether 36, separate to any other possible connections such as power or control cabling that might be present and that might act partially (but sub-optimally) as a tether. The dedicated tether 36 is adapted so as to be removably couplable to the strut 30 and machine 1 via tether coupling feature 36a and 36b. As shown in FIG. 24, when the machine 1 is inadvertently controlled to impart an upward movement M to the end effector 3 that results in a separation between support members 33 that is larger than can be accommodated by a travel range of the strut 30, the strut 30 becomes decoupled (in this example) from the upper (moving) support member 33. However, the strut 30 remains attached to the machine 1 via the tether 36, even if not in a directly-usable state because it is no longer coupled to the upper (moving) support member 33, thereby preventing it from falling to the machine bed 2 and becoming damaged. Even when the tether 36 is itself fully extended, so that a further upward movement M causes the strut 32 to become decoupled also from the lower (fixed) support member 33, the strut 32 will still remain attached to the machine 1 via the tether 36. Such a tether 36 could be provided at both ends of the strut 30, to prevent the bottom end of the strut 30 from swinging after becoming detached, with a risk of crashing into another machine part. The tether 36 is sufficiently flexible that it does not meaningfully interfere with a normal interaction between the strut 30 and the machine, for example by imparting a force on the strut 30 that might have an effect on measurements from the strut 30.

It is to be noted that the tether feature of the second aspect can be used independently of the offset coupling feature of the first aspect. In other words, the tether feature of the second aspect can be used, for example, in combination with a strut as shown in FIGS. 4 and 5, which does not have the offset coupling feature of the first aspect.

An embodiment of a third aspect of the present invention will now be described with reference to FIGS. 25 and 19, which show a measurement strut 30 coupled between two support members 33 of a machine such as a robot arm 1. This embodiment is based very closely on the above-described embodiments relating to the first and second aspects, with like reference numerals referring to like parts so that a further description of these like parts is not required. The strut 30 of FIGS. 25 and 19 differs from earlier embodiments by being provided with asymmetric magnetic coupling strengths, as will be described in more detail below. This is to solve a problem identified by the present applicant, which is related to the problem described above with reference to the second aspect, associated with machine movements beyond the maximum travel range of the strut. An embodiment of this aspect also solves another technical problem identified by the present applicant, which is that a typical calibration procedure involving a ballbar or other form of measurement strut typically involves significant manual intervention, in particular to move the ballbar or strut from one mounting position to another e.g. on the machine bed, which leads to inefficiencies and the risk of operator error (for example, moving the strut to the wrong mounting position).

Accordingly, the measurement strut 30 of FIG. 25 is provided with a magnet 37a at one end that a higher magnetic strength than a magnet 37b provided at the other end. This is signified in FIG. 25 by the larger form of magnet 37a in strut member 32 compared to magnet 37b in strut member 34, though in practice a higher magnetic strength does not necessarily require a physically larger magnet. The end having the stronger magnet 37a would be coupled to the moving support member 33 (i.e. that which is fixed to the flange 3 of the robot arm 1), and this ensures that when the separation between the two support members 33 increases beyond what can be handled by the range of the strut 30, the lower end of the strut 30 (coupled to the support member 33 fixed to the machine bed 2) will decouple first, before the upper end of the strut 30, because of the stronger magnetic coupling strength of the magnet 37a at the upper (moving) end. Therefore, although the strut 30 may swing from the upper support member 33, this is preferable to crashing to the machine bed 2 if it were to decouple at its upper end.

Although in this example the end connected to the robot 1 has the stronger coupling strength, this could be reversed such that the stronger coupling strength is provided at the end that is not coupled to the robot 1, particularly where the strut is arranged above the robot 1. Therefore, it could be considered to be preferable if the upper end (relative to gravity) is provided with the stronger coupling, so that it is the lower end (relative to gravity) that becomes decoupled and so that the upper end remains supported (and so that the strut does not fall).

As well as its use as a safety feature, to deal with an unintended event such as described above, the asymmetric coupling strength concept can also be used more deliberately, for example as part of a calibration method, as will now be described with reference to FIGS. 26A to 26D. FIG. 26A shows the strut 30 of FIG. 25 coupled between a moving support member 33m and a first fixed support member 33a. In this configuration, the machine (e.g. robot arm) could for example have been performing a series of movements such as those described with reference to FIGS. 2 and 3, to gather measurement data as part of the calibration method. Following this series of movements, the calibration method then requires the strut 30 to be decoupled from first fixed support member 33a, and coupled instead to a second fixed support member 33b. Making use of this aspect of the present invention, this can be achieved as shown in the series of steps shown in FIGS. 26B to 26D.

As shown in FIG. 26B, the robot arm 1 first moves the upper support member 33m so that it is vertically above the first lower support member 33a, thereby placing the strut 30 into a vertical pose. Then, as shown in FIG. 26C, the robot arm 1 performs a controlled upward movement of the upper support member 33m so that the strut 30 reaches its maximum extension range and thereafter becomes decoupled because it cannot extend any further. Because of the asymmetric coupling strengths in this embodiment, the strut 30 remains coupled at its upper end and decouples instead at its lower end, so that the strut 30 remains supported (and moveable) by the robot arm 1 via the upper support member 33m. Consequently, as shown in FIG. 26D, the robot arm 1 can be controlled to move the dangling strut 30 over to the second support member 33b and then lowered so that the lower end of the strut 30 couples to the second support member 33b. Following this, further steps of the calibration method can be performed to collect more calibration data.

Therefore, by using the asymmetric coupling strength feature of the third aspect, manual intervention is not required to move the strut 30 from one support member 33a to the next support member 33b, making the process more efficient, quicker, and less prone to operator error. As noted above already, this aspect of the present invention is not limited to the use of a magnetic coupling force, and a spring or other form of resilient member could be used instead of a magnet to create an attractive holding or coupling force. Purely as general guidance, and not to imply any limitation to the scope of the present invention as set out in the appended claims, the coupling at one end of the strut 30 may be stronger than the coupling at the other end by a factor of at least 1.2, or may be stronger by a factor of at least 1.2, or may be stronger by a factor of at least 2, or may be stronger by a factor of at least 5, or may be stronger by a factor of at least 10. However, the smaller coupling strength should also be above a predetermined value required to keep the strut 30 coupled during normal use, and the larger coupling strength should be below a predetermined value so as to avoid creating too much friction between the strut 30 and support member 33; the skilled person will readily be able to determine what is suitable depending on the application concerned. It is to be noted that the asymmetric coupling strength feature of the third aspect can be used independently of the offset coupling feature of the first aspect and the tethering feature of the second aspect. In other words, the asymmetric coupling strength feature of the third aspect can be used, for example, in combination with a strut as shown in FIGS. 4 and 5, which has neither the offset coupling feature of the first aspect nor the tethering feature of the second aspect.

The features of the first, second and third aspects can also be used together in any combination. For example, an offset coupling feature associated with the first aspect could be applied to the strut 30 of FIG. 25, at either end of the strut 30. Or the asymmetric coupling strength feature associated with the third aspect could be applied to the strut 30 of FIGS. 23 and 17, again in either direction.

It should also be noted that the first, second and third aspects can be considered to be unified in the sense that they all solve a common technical problem, which is avoiding damage to the strut when an attempt is made to operate the strut outside its normal range of travel.

A machine controller for controlling the operation of the robot (or other type of coordinate positioning machine) is also provided. The machine controller may be a dedicated electronic control system and/or may comprise a computer operating under control of a computer program. For example, the machine controller may comprise a real-time controller to provide low-level instructions to the coordinate positioning machine, and a PC to operate the real-time controller.

It will be appreciated that operation of the coordinate positioning machine can be controlled by a program operating on the machine, and in particular by a program operating on a coordinate positioning machine controller such as the controller illustrated schematically in FIG. 1. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A measurement strut for measuring a separation between two relatively moveable support members of a machine, the strut being removably couplable between the two support members and being adapted to become at least partially decoupled from at least one of the support members when a compressive force developed in the strut by relative movement of the support members is greater than a predetermined threshold.

2. A measurement strut for measuring a separation between two relatively moveable support members of a machine, the strut being removably couplable between the two support members and having a dedicated tether which is adapted catch the strut should it become decoupled from at least one of the support members.

3. A measurement strut for measuring a separation between two relatively moveable support members of a machine, the strut being removably couplable between the two support members and being adapted to couple more strongly to one of the support members than the other.

4. (canceled)

5. A measurement strut as claimed in claim 1, wherein: the strut is adapted to become at least partially decoupled from at least one of the support members when relative movement of the support members attempts to operate the strut beyond a minimum end of a predetermined range of travel for the strut; and/or wherein the compressive force developed in the strut by relative movement of the support members becomes greater than the predetermined threshold when relative movement of the support members attempts to operate the strut beyond a minimum end of a predetermined range of travel for the strut; wherein the predetermined range of travel is for example a range of travel beyond which the strut is likely to incur mechanical damage.

6. (canceled)

7. (canceled)

8. A measurement strut as claimed in claim 1, wherein the predetermined threshold is substantially independent of an angle of the strut relative to the relevant support member, or is at least, for any such angle, less than a compressive force under which the strut is likely to incur mechanical damage.

9. A measurement strut as claimed in claim 1, wherein the support member comprises a bearing surface and the strut is provided with a coupling which is adapted to bear against and slide over the bearing surface of the support member, thereby creating contact between the coupling of the strut and the bearing surface of the support member.

10. A measurement strut as claimed in claim 9, wherein: the coupling of the strut provides a recess into which the bearing surface of the support member is received; and/or wherein the coupling of the strut has a generally concave or cup-shaped or female form, and the bearing surface of the support member has a generally convex or at least part-spherical or male form.

11. A measurement strut as claimed in claim 9, wherein the contact created between the coupling of the strut and the bearing surface of the support member is arranged to one side of a longitudinal axis of the measurement strut.

12. A measurement strut as claimed in claim 9, wherein the bearing surface of the support member is an at least part-spherical bearing surface, the centre of the spherical part of the bearing surface defining or coinciding with a point of measurement for the strut when coupled to the support member.

13. A measurement strut as claimed in claim 9, wherein the support member bears directly onto a surface within the coupling, thereby creating a surface-to-surface contact between the coupling of the strut and the bearing surface of the support member, or discrete contact features are provided within the coupling, thereby creating a more point-like contact between the coupling of the strut and the bearing surface of the support member.

14. A measurement strut as claimed in claim 9, wherein the coupling comprises a plurality of contact features which are raised or which protrude above a surrounding surface of the coupling to create the contact between the coupling of the strut and the bearing surface of the support member and to form a coupling to the bearing surface.

15. A measurement strut as claimed in claim 14, wherein the coupling comprises three such contact features forming a kinematic or pseudo-kinematic coupling to the bearing surface.

16. A measurement strut as claimed in claim 14, wherein: a contact angle for each contact feature is above a predetermined threshold, for example above a friction angle; and/or wherein a coupling angle for the coupling is above a predetermined threshold, the coupling angle being defined as the angle between a plane which contains the contact features, or the contact points created by the contact features on the support member, and a plane that is perpendicular to a longitudinal axis of the measurement strut.

17. A measurement strut as claimed in claim 14, wherein the coupling of the strut is adapted such that compressive forces developed in the strut during a relative movement of the two support members act on the bearing surface of the support member, through the contact features of the strut coupling, to create a net decoupling force.

18. A measurement strut as claimed in claim 17, wherein during normal operation of the strut the decoupling force is lower than a coupling force, such as a magnetic coupling force, which holds the strut to the bearing surface, the decoupling force generally increasing with an increasing compressive force in the strut until it overcomes the coupling force holding the strut, such that the strut becomes decoupled from the machine.

19. (canceled)

20. A measurement strut as claimed in claim 17, wherein the coupling of the strut is adapted such that, should any additional contact features be created between the coupling of the strut and the bearing surface of the support member during the process of decoupling due to movement and/or rotation of the strut, then any remaining of the original contact, plus any such additional contact, still results in a net decoupling force which enables the decoupling process to be completed.

21-23. (canceled)

24. A measurement strut as claimed in claim 1, wherein the strut is a mechanical strut and/or a passive measurement strut.

25-27. (canceled)

28. A kit for characterising a machine, comprising a measurement strut as claimed in claim 1 and the support members to which the measurement strut is couplable, or at least any support member from which the measurement strut is adapted to become at least partially decoupled.

29. (canceled)

30. A method of characterising a machine, for example a coordinate positioning machine such as a robot arm, comprising coupling a measurement strut as claimed in claim 1 between the relatively moveable support members of the machine, controlling the machine to perform a sequence of movements, collecting measurement data from the strut during the sequence of movements, and using the collected measurement data to characterise the machine.

31. A method of characterising a machine, for example a coordinate positioning machine such as a robot arm, comprising coupling a measurement strut as claimed in claim 3 between the relatively moveable support members of the machine, controlling the machine to perform a sequence of movements, collecting measurement data from the strut during the sequence of movements, and using the collected measurement data to calibrate the machine, wherein the end having a stronger coupling is coupled to a moveable support member and the other end is coupled in turn to a plurality of fixed support members by controlling the machine to move the currently-active support members relative to one another so that, due to the different coupling strengths, the strut remains coupled to the moveable support member but becomes decoupled from the fixed support member, and then controlling the machine to move the strut, still coupled to the moveable support member, so as to couple to another of the fixed support members for performing further movements of the sequence.

32-37. (canceled)

38. A computer program which, when run by a computer or a machine controller, causes the computer or machine controller to perform a method as claimed in claim 30.

39. A computer-readable medium having stored therein computer program instructions for controlling a computer or a machine controller to perform a method as claimed in claim 31.

40. A machine controller configured to control a machine to perform a method as claimed in claim 30.

41. A machine controller configured to control a machine to perform a method as claimed in claim 31.
